(19) United States
(12) Patent Application Publication
(10) Pub. No.: US 2009/0224932 A1
(43) Pub. Date: Sep. 10, 2009

(54) SYSTEM, DEVICE AND METHOD FOR PROVIDING ONSITE INFORMATION TO AID VISUALLY AND/OR HEARING IMPAIRED PERSONS

(76) Inventors: Moshe KILIM, Gan Soreq (IL); Marcel GROSSMAN, Wanchai (HK)

Correspondence Address: LADAS & PARRY LLP, 224 SOUTH MICHIGAN AVENUE, SUITE 1600, CHICAGO, IL, 60604, US

(21) Appl. No.: 12/274,569

(22) Filed: Nov. 20, 2008

Related U.S. Application Data
(60) Provisional application No. 61/033,851, filed on Mar. 5, 2008.

(51) Int. Cl. G08B 21/00

(52) U.S. Cl. 340/686.6

(57) ABSTRACT

A system, device and associated methods are presented for use in providing onsite information to visually impaired persons. The system includes an announcement device and a personnel device. The announcement device is configured to be installed at an onsite location, such as at a traffic light and on a taxicab. The announcement device is configured to emit an identification signal in which it is preferable that the identification signal is continuously emitted. The personnel device is configured to detect the identification signal so that the personnel device is able to alert the visually impaired person that the announcement device is located nearby. The personnel device is also configured to allow the person to select and activate a desired feedback selection signal to transmit from the personnel device to the announcement device so that the announcement device can subsequently transmit back any number of different announcement signals such as direction signals, electronic signals, audio signals, and visual signals.

### FIELD OF THE INVENTION

The present invention relates to visually impaired persons information systems and more specifically to system, device and associated methods that provide onsite information for use in aiding visually impaired persons.

### BACKGROUND OF THE INVENTION

Like any other person a visually impaired person needs to move and navigate within public areas such as public transportation stations, street crossings, pedestrian traffic lights and similar settings. Visually impaired persons need to get oriented inside the public buildings such as hotels, hospitals, and museums. Traditional primary walking aids for the visually impaired persons include guide dogs, walking canes and reliance on personal memory. Secondary walking aids include sophisticated electronic walking aids such as laser canes and sonar-based devices. The main limitation of such devices is that they provide little or no information regarding a user's orientation with respect to the general environment.

The advent of global positioning systems (GPS) and cellular telephone networks offers some hope of delivering to visually impaired persons and blind persons information helping to bring them to a desired target destination or describing their location and general environment with a relatively high accuracy. The cost of such devices is almost prohibitive for wide use and they are almost not effective when the vision impaired person is inside public buildings looking for a specific destination such as ticket counter, toilet etc.

There is a need to have a cost effective information delivery system and method for visually impaired persons, which may be located on every site, aiding them better navigate through complex environments.

### SUMMARY OF THE INVENTION

According to one aspect of the present invention, there is provided an apparatus and method for utilizing announcement devices physically installed at public areas, and personnel devices operated by the visually impaired persons. The personnel devices are capable of remotely activating the announcement devices located in proximity to the visually impaired person to provide relevant audio information on the site visited by the visually impaired person.

The present system, device, and method of using, according to the principles of the present invention, overcomes a number of the shortcomings of the prior art by providing a novel system, device, and method for use in aiding visually impaired persons at or near onsite locations. The system includes an announcement device and a personnel device. The announcement device is configured to be installed at an onsite location, such as at a traffic light, on a bus or in a building. The announcement device is configured to emit an identification signal in which it is preferable that the identification signal is continuously emitted. The personnel device is configured to detect the identification signal so that the personnel device is able to alert the visually impaired person that the announcement device is located nearby. The personnel device is also configured to allow the person to select and activate a desired feedback selection signal to transmit from the personnel device to the announcement device so that the announcement device can subsequently transmit back any number of different announcement signals such as direction signals, electronic signals, audio signals, and visual signals.

In view of the foregoing need of aiding the visually impaired persons at unknown onsite locations, the present invention provides an improved system, device and method, which will be described subsequently in great detail, which is not anticipated, rendered obvious, suggested, or even implied by the prior art, either alone or in any combination thereof.

To attain this, the present invention essentially comprises an announcement device and a personnel device. The announcement device is configured to be installed at an onsite location, such as at a traffic light, on a bus or in a building. The announcement device is configured to emit an identification signal in which it is preferable that the identification signal is continuously or intermittently emitted. The personnel device is configured to detect the identification signal so that the personnel device is able to alert the visually impaired person that the announcement device is located nearby. The personnel device is also configured to allow the person to select and activate a desired feedback selection signal to transmit from the personnel device to the announcement device so that the announcement device can subsequently transmit back any number of different announcement signals such as direction signals, electronic signals, audio signals, and visual signals.

There has thus been outlined, rather broadly, the more important features of the invention in order that the detailed description thereof that follows may be better understood, and in order that the present contribution of the art may be better appreciated.

The system invention may also include a plurality of announcement devices, a plurality of personnel devices, a central computer, and a local area network.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an aspect of the present invention to provide a new and improved system, device and method for aiding the visually impaired so that they may more conveniently maneuver along unknown locations.

It is another aspect of the present invention to provide a new and improved system and associated devices that may be easily and efficiently manufactured and marketed.

An even further aspect of the present invention is to provide a new and improved system and associated devices that has a low cost of manufacture with regard to both materials and labor, and which accordingly is then susceptible of low prices of sale to the consuming public, thereby making the system and the associated devices economically available to the buying public.

Even still another aspect of the present invention is to provide system includes an announcement device and a personnel device.

Still another aspect of the present invention is to provide an announcement device which is configured to emit an identification signal.

Yet another aspect of the present invention is to provide a personnel device which is configured to detect the identification signal so that the personnel device is able to alert the visually impaired person that the announcement device is located nearby.

Even yet another aspect of the present invention is to provide a personnel device which is also configured to allow the person to select and activate a desired feedback selection signal to transmit from the personnel device to the announcement device so that the announcement device can subsequently transmit back any number of different announcement signals such as direction signals, electronic signals, audio signals, and visual signals.

Lastly, it is an aspect of the present invention to provide a new and improved method of using comprising the steps of alerting, detecting, emitting, installing, pushing, receiving, sending, and transmitting.

There has thus been outlined, rather broadly, the more important features of the invention in order that the detailed description thereof that follows may be better understood, and in order that the present contribution of the art may be better appreciated.

Numerous other features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other aspects of the invention, along with the various features of novelty that characterize the invention, are pointed out with particularity in the claims annexed to and forming a part of this disclosure. For a better understanding of the invention, its operating advantages and the specific aspects attained by its uses, reference should be had to the accompanying drawings and description matter in which there are illustrated preferred embodiments of the invention.

Before undertaking the DETAILED DESCRIPTION OF THE PREFERRED EMBODIMENTS below, it may be advantageous to set forth definitions of certain words and phrases used throughout this patent document: the terms “include” and “comprise,” as well as derivatives thereof, mean inclusion without limitation. Further as used in the specification, “a” or “an” may mean one or more. As used herein in the claim(s), when used in conjunction with the word “comprising”, the words “a” or “an” may mean one or more than one.

### BRIEF DESCRIPTION OF THE DRAWINGS

The apparatus and method are particularly pointed out and distinctly claimed in the concluding portion of the specification. The apparatus and the method, however, both as to organization and method of operation, may best be understood by reference to the following detailed description when read with the accompanied drawings, in which like reference characters refer to the same parts throughout the different views. The drawings are not necessarily to scale, emphasis instead being placed upon illustrating the principles of the method.

FIG. 1 is a schematic illustration of an exemplary embodiment of a system providing orientation information to a visually impaired person;

FIG. 2 is a schematic illustration of an exemplary embodiment of an announcement device attached to a traffic light and providing orientation information for a visually impaired person;

FIG. 3 is a schematic illustration of an exemplary embodiment of a personnel device;

FIG. 4 is a schematic illustration of an exemplary embodiment of the announcement device;

FIG. 5 is a schematic illustration of an exemplary networked announcement configuration;

FIG. 6 is a schematic illustration of various exemplary configurations of announcement devices and a personnel device with an integrated announcement module;

FIG. 7 a schematic illustration of an exemplary embodiment of an identification module attached to an electric or hybrid vehicle transmitting information for a visually impaired person on proximity of such vehicles;

FIG. 8 a schematic illustration of an exemplary embodiment of an identification module attached to cab transmitting information for a visually impaired person on proximity of such vehicles; and

FIG. 9 a schematic illustration of an exemplary embodiment of an identification module attached to a passenger bus transmitting information for a visually impaired person on proximity of such vehicles.

### DETAILED DESCRIPTION OF THE PREFERRED EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Further, it should be understood that, although steps of various the claimed method may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

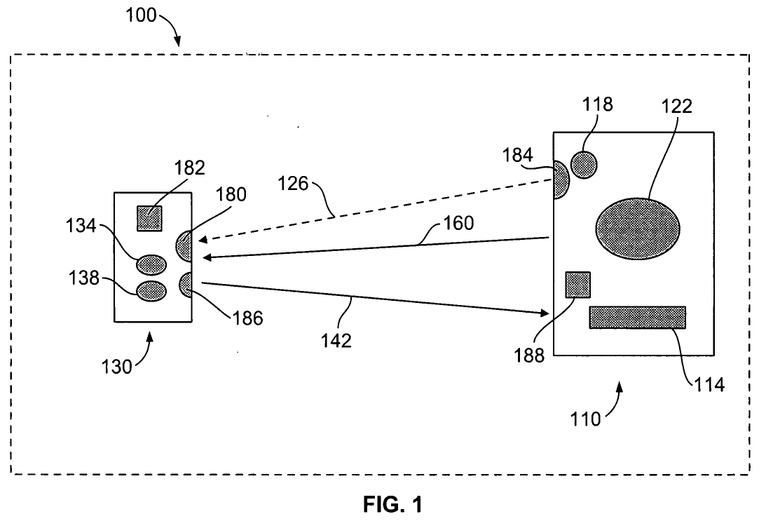

Referring now to the drawings, and in particular FIGS. 1 to 9 thereof, one preferred embodiment of the present invention is shown and generally designated by the reference numeral 100.

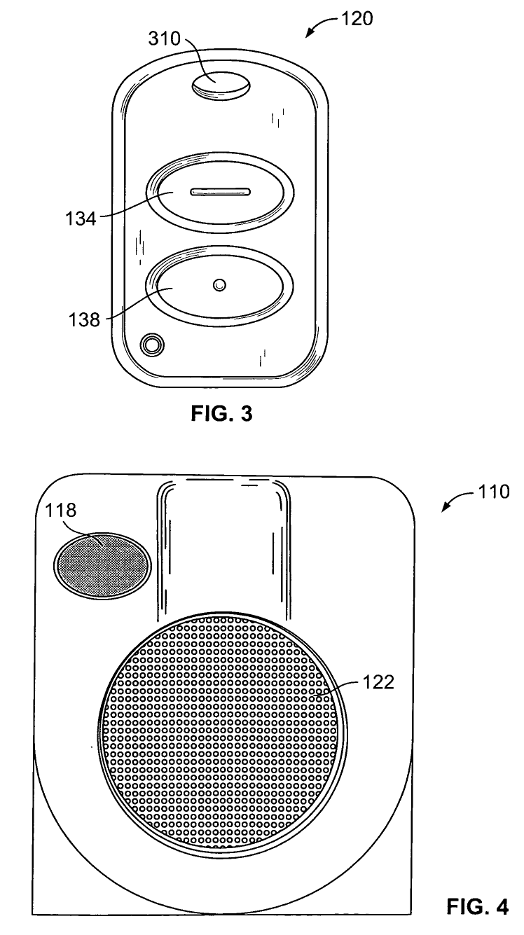

FIG. 1 is a schematic illustration of an exemplary embodiment of a system providing orientation information to a visually impaired person 210. System 100 includes two main devices that are communicating between each other including an announcement device 110, an exemplary embodiment of which is shown in detail in FIG. 4 and a personnel device 130, an exemplary embodiment of which is shown in detail in FIG. 3.

FIG. 1 describes a system providing orientation information to a visually impaired person 210. An announcement device 110 permanently installed at public area onsite locations 220 such as those selected from the group consisting of a traffic light onsite location 220, a car onsite location 220, a taxicab onside location, an elevator onsite location 220, an entranceway onsite location 220, a doorway onsite location, a train onsite location 220, and a bus onsite location 220.

Announcement device 110 includes a message storage facility 114 such as a non volatile memory to store a plurality of recorded announcements, optionally a notification indicator 118 such as those selected from the group consisting of a strobe light notification indicator 118, a incandescent bulb notification indicator 118, a light emitting diode notification indicator 118, an electric arc notification indicator 118, a moving sign notification indicator 118, a liquid crystal notification indicator 118, a flashing sign notification indicator 118, and an audible notification indicator 118. A preferred embodiment of the strobe light notification indicator 118 is that is able to emit well visible color to indicate for the visually impaired person 210 that is not completely blind and is walking in proximity to the announcement device 110 the location and help him to identify the location of device 110.

Announcement device 110 also includes an announcement module 122 (also referred to as a transmitter 122) to announce one of the previously recorded announcements. A distance measurement module 146 may be also be included into announcement device 110. The distance measurement module 146 is configured to measure the approximate position of the visually impaired person 210. The optional measuring module 146 may be selected from the group consisting of a radar measuring module 146, a radio frequency signal intensity measuring module 146, an induction loop signal intensity measuring module 146, an infrared signal intensity measuring module 146, an acoustic signal intensity measuring module 146, an ultrasound signal intensity measuring module 146, and an infrasound signal intensity measuring module 146.

The personnel device 130, is used by the visually impaired person 210 to remotely activate the messages storage facility 114 to transmit one of the previously recorded announcement signals which is stored at the messages storage facility 114. The personnel device 130 can be a dedicated remote control personnel device 130. Alternatively, its function can be integrated into a mobile personnel device 130, palm computer personnel device 130 or into a walking cane personnel device 130 used by the visually impaired.

One preferred embodiment is that the announcement device 110 constantly transmits the identification signal 126, which may be a radio frequency identification signal 126. Alternatively, the identification signal 126 can be generated by an induction loop element identification signal 126 installed at the announcement device 110. Accordingly, the transmitter 122 (also referred to as the announcement module 122) may be selected from the group consisting of a radio frequency transmitter 122 and an induction loop transmitter 122. The personnel device 130 is configured to receive and detect the identification signal 126 emitted from announcement device 110. The received signal can be in a form of a radio frequency signal or an induction loop element identification signal 126 generated by device 110. Accordingly, the detector 180 of the personnel device 130 may be selected from the group consisting of a radio frequency detector 180 and an induction loop detector 180. Further the induction loop detector 180 may be a coil—‘T’ switch detector 180 installed in device 130 mounted in a hearing aid personnel device 130 for the benefit of deaf or hearing impaired persons.

A visually impaired person 210 equipped with a personnel device 130, walking in proximity to a device 110 will get an indication from an alerting component 654 (also referred to as a responder 182) on his personnel device 130. The alerting component 654 may produce any number of alert signals such as those selected from the group consisting of an audible alert signal, a buzzer alert signal, a notification signal, an electrical pulse signal, and a vibrating alert signal. This indication will alert the person 210 on the fact that a suitable announcement device 110 is located within the range of his personnel device 130.

The visually impaired person 210 may choose to activate the announcement device 110 to announce a previously recorded message relevant to his walking location. In order to activate such an announcement, the visually impaired person 210 will need to select the proper announcement by pressing on one of the buttons, i.e., either the first button 134 or the second button 138 or by pressing on a combination sequence of buttons 134, 138. The combination sequence provides the ability to select from a wider range of options. For example an ordered sequence combination can be pushed on the buttons 134, 138 by pressing twice in a row can generate 4 combinations in the case where two buttons 134 and 138 are used (2 in power of 2). The push buttons 134, 138 are located on the personnel device 130 and are distinguished from each other by Braille type protrusion facilitation suitable for use for visually impaired persons 210 or by geometric form. The selection of the desired announcement will cause a feedback selection signal 142 to be remotely broadcast back to the announcement device 110. In response the announcement device 110 can activate a prerecorded announcement signal 160 to be transmitted. In addition the device 110 can also optionally activate the notification indicator 118.

Each of the push buttons 134, 138 or their sequence combination may represent a selection for a similar announcement a desired language, for example English or Spanish.

The distance measured by the optional distance measuring module 146 may optionally be used to influence the type and/or magnitude of the subsequently transmitted announcement signal 160. For example, in the event that a person 210 is identified at a distance of say 5 meters from a desired location, the announcement device 110 will transmit a different announcement signal 160 as compared to a person 210 standing at 10 meters from that same location. Alternately, when the announcement signal 160 is transmitted from the announcement device 110 to the personnel device 130, personnel device 130 can be configured to generate a corresponding alert signal that gradually increases in intensity as a the person 210 nears the announcement device 110.

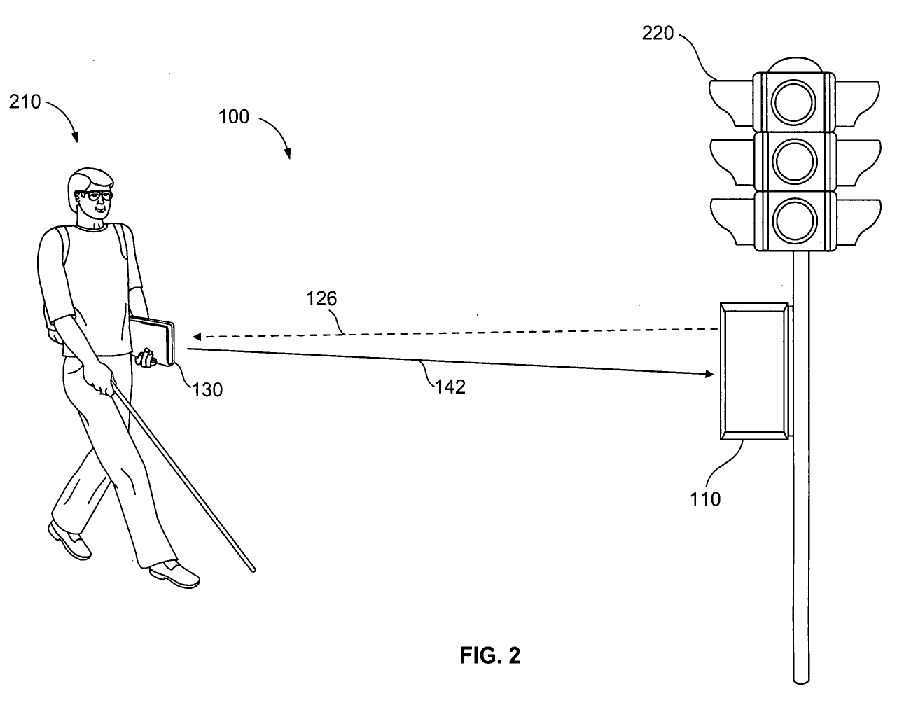

FIG. 2 illustrates one way of using the system 100 by a visually impaired person 210 trying to cross a road at a traffic light onsite location 220. An announcement device 110 is shown physically installed on the traffic light onsite location 220 and the announcement device 110 is shown constantly or intermittently emitting the identification signal 126. The personnel device 130 is shown being carried by person 210 in which the personnel device 130 receives or detects the identification signal 126 in which the personnel device 130 indicates to the person 210 that an announcement device 110 is located in proximity to that person 210. The person 210 can then selects a desired feedback selection signal 142 which then subsequently activates the announcement device 110 to transmit back a corresponding announcement signal 160 which was previously stored in the storage facility 114 of announcement device 110. This can be accomplished by pressing push buttons 134, 138 or a sequence combination of the buttons. The announcement signal 160 may correspond to a state of the status of the traffic light onsite location, such as, Green, Yellow or Red announcement signals 160. Again the announcement signals 160 may be any type of announcement signals 160 such as those selected from the group consisting of a light announcement signal 160, a siren announcement signals 160, a periodic beeping announcement signal 160, a digital data files announcement signals 160, an electromagnetic pulses announcement signals 160, and a different languages announcement signals 160. Further the announcement signal 160 may be in a form of a direction of a specific street name or crossing, thus helping person 210 to get better oriented.

Another embodiment of system 100 usage can be an information system installed at public buildings. In this embodiment a plurality of announcement devices 110 can be located next to every elevator stop, as well as, at every corridor junction for example. The announcement signals 160 can be automatically activated by the person 210 in possession of the personnel device 130 in which the announcement signals 160 can be used to aid or direct the visually impaired person 210 on the floor number associated with the elevator stop in addition to direction information aiding person to reach a certain room or department located on the same floor. Such an announcement signal 160 might read: “for rooms 100-150 turn left and for rooms 151-200 turn to the right”.

FIG. 3 depicts a personnel device 130 that can be made wearable. This is done by introducing a wearable notch 310 into which a wearing chain or a lace can be inserted to hold the personnel device 130.

FIG. 4 depicts an announcement device 110 having a notification indicator 118 and an announcement module 122 (also referred to as a transmitter 122).

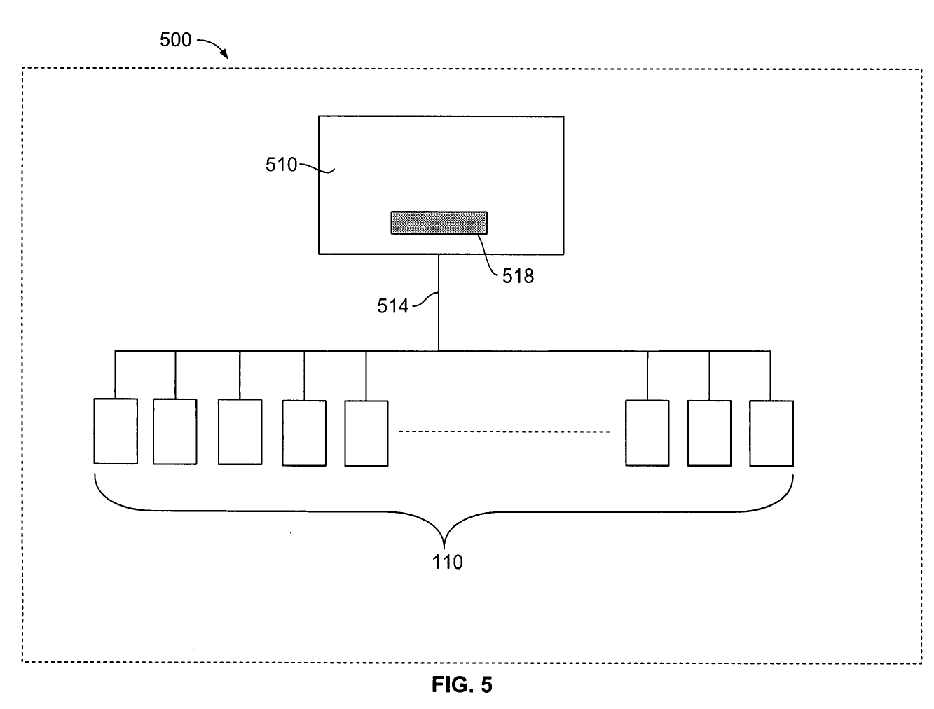

In another embodiment of this invention, a method and apparatus of a networked announcement configuration 500 is shown in FIG. 5. A central announcement storage facility 518 used to store plurality of audio announcements is integrated in a central computer 510. The announcement signals 160 are delivered to an announcement device via a local area network 514 on demand, by the visually impaired person 210 using an appropriate personnel device 130.

The networked announcement configuration 500 is suitable where announcement devices 110 will be installed in large quantities. For example, in the case of a hotel or a large public building such a device will be placed at every elevator stop, or even in a corridor junction or along a corridor, instructing the visually impaired as to which direction to proceed. Loading each of the announcement devices with a proper message may be tedious work.

A central computer 510 with a storage facility 518 will allow recording all audio announcement signals 160 at a single location, without the need to record the message in proximity to every announcement device 110. This scheme will also greatly simplify the alteration of previously recorded messages, as well as the addition of new messages. The central computer 510 will be able to deliver the announcement signals 160, via a local area network (LAN) 514, which typically exists today in every modern office, to the appropriate announcement device 110.

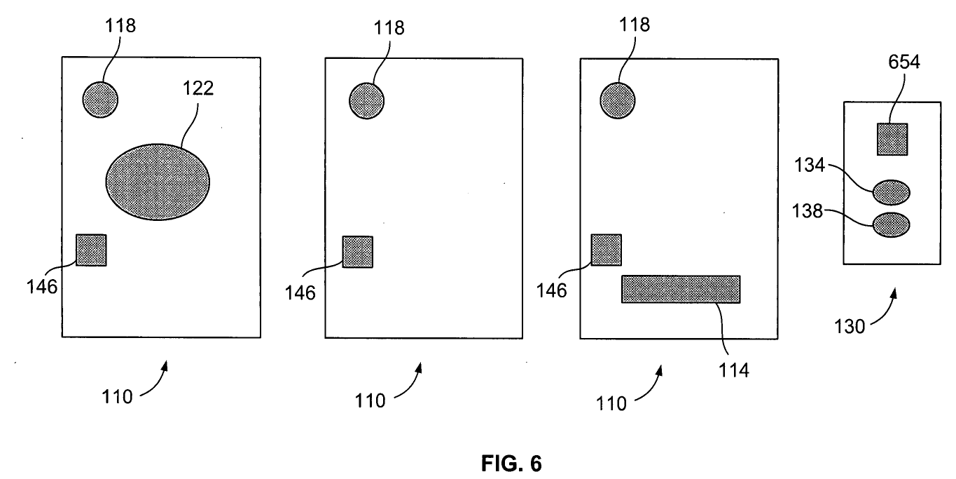

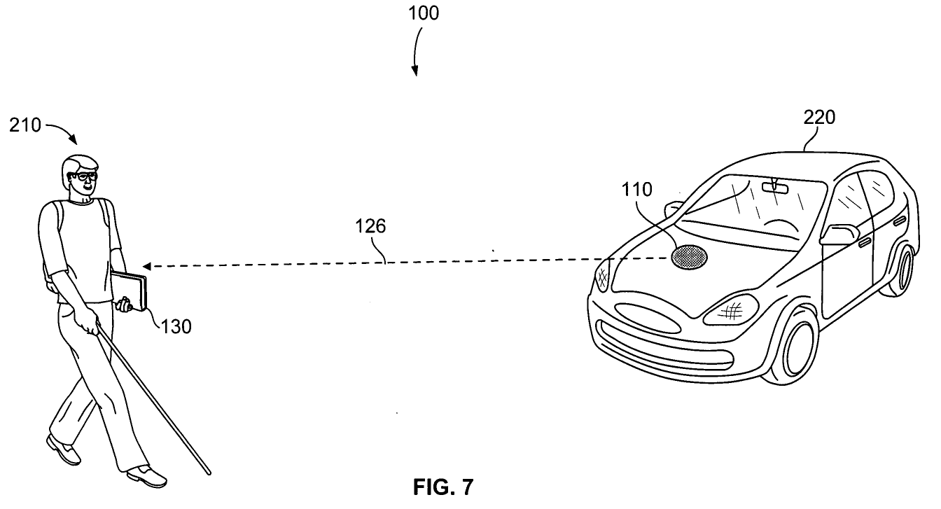

FIG. 6 depicts various configurations of announcement devices 110 that may fit the particular needs of a networked announcement configuration 500. One announcement device 110 is shown having an integrated announcement module 122, a notification indicator 118, and a measured distance monitoring module 146. Another announcement device 110 is shown having a notification indicator 118 and a measured distance monitoring module 146. Yet another announcement device 110 is shown having a notification indicator 118, a measured distance monitoring module 146, and a message storage facility 114. The personnel device 130 is shown having a plurality of buttons 134, 138 and an alerting component 654. The alerting component 654 is for alerting the person 210 which is capable of producing an alert signal selected from the group consisting of an audible alert signal, a buzzer alert signal, a notification alert signal, an electrical pulse alert signal, and a vibrating alert signal.

The alerting component 654 can be used for playing selected audio messages on the personnel device 130. The alerting component 654 can be physically integrated into the personnel device 130 or alternatively configured to control a wearable Bluetooth headset.

The personnel device 130 can be configured to enable any of the announcement devices 110 depicted in FIG. 6. The personnel device 130 can also comprises a backup local storage facility 114, which may be used for backup purposes, in cases where the local area network 514 fails temporarily.

The personnel device 130 with an alerting component 654 enables playing the audio message in proximity to the visually impaired person 210, even directly into his headset, thus reducing the noise generated to other pedestrians by avoiding publicly playing the audio message.

The networked announcement configuration 500 can deliver the announcement signals 160 to any type of announcement devices 110 depicted in all of the figures.

In another embodiment of the method and apparatus of identification and notification to visually impaired person 210 of cars, i.e., onsite locations 220, with silent engines is shown in FIG. 7. Cars equipped with electric engine such as electric or hybrid car 710 are very silent and a visually impaired person 210 might not notice such cars even in proximity to him. An announcement device 110 is shown installed in car onsite location 220 which constantly transmitting an identification signal 126. A visually impaired person 210 carrying a personnel device 130 will receive the transmitted identification signal 126 which subsequently indicates to the visually impaired person 210 the fact that silent cars are in proximity to him. The strength of the an identification signal 126 sent from the announcement device 110 or the sensitivity of the personnel device 130 may be set such that the personnel device 130 carried by visually impaired person 210 will be able of detecting it from relatively greater distances such as at a distance of 20 meter, or 50 meter or even at a distance of 100 meter.

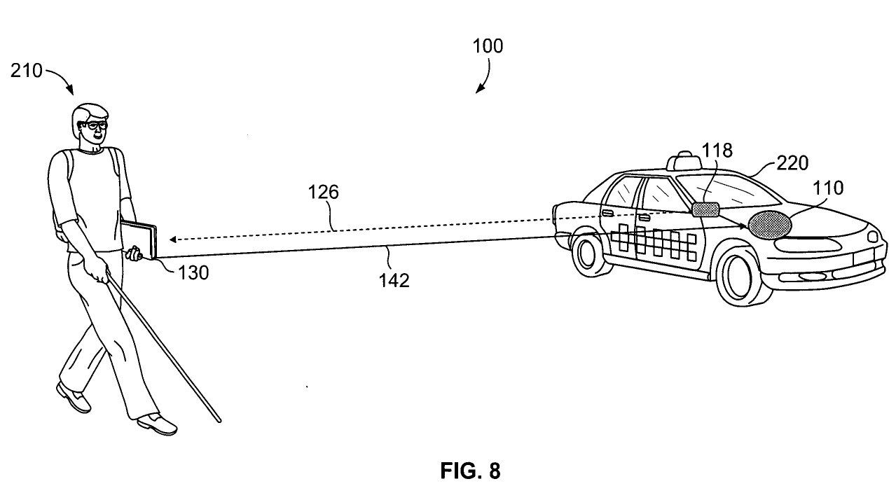

A similar embodiment is depicted in FIG. 8. A taxicab can also be defined as a onsite location 220 such that an announcement device 110 can be installed in the taxicab. The announcement device 110 can be configured to transmit an identification signal 126 which can be used to indicate the fact that a cab is proximate to the personnel device 130 held by the person 210. A visually impaired person 210 will receive identification signal 822 into the personnel device 130. The visually impaired person 210 may elect to to communicate to the taxicab onsite location 220 by pressing on buttons 134, 138 or a combination thereof which subsequently transmits a feedback selection signal 142 to taxicab onsite location 220. The received feedback selection signal 142 will set the notification indicator 118, and will thus indicate to the cab driver on a visually impaired person 210 in proximity, which is looking for a cab.

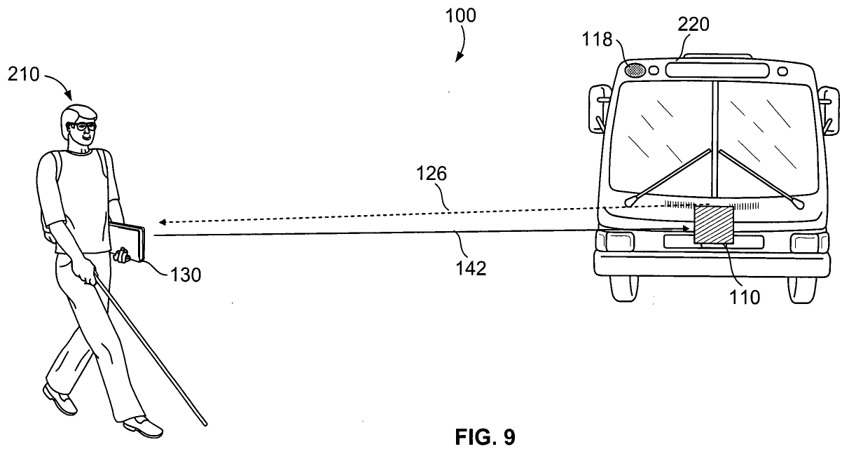

Still yet another embodiment of the method and apparatus of identification and notification to visually impaired person 210 of passenger bus in proximity is shown in FIG. 9. A passenger bus can also be viewed as an onsite location 220 such that an announcement device 110 can be mounted on the bus onsite location 220 so that the mounted announcement device 110 is constantly transmitting an identification signal 126. The identification signal 126 may even include the particular bus number information, in digital and/or in audio form. The visually impaired person 210 equipped with a personnel device 130 with an integral alert component 654 may choose to notify the bus driver by pressing on buttons 134 or 138, or a combination of buttons thereof. This will transmit the feedback selection signal 142 to the passenger bus which then subsequently activates the notification indicator 118 into an “ON” state. The notification indicator 118 will indicate to the bus driver that a visually impaired person 210 is nearby and is seeking bus service.

A system 100 for providing onsite information to a visually impaired person 210 comprises an announcement device 110 and a personnel device 130. The announcement device 110 is configured to be installed at an onsite location 220 in which the announcement device 110 is configured to emit an identification signal 126. The personnel device 130 is configured to detect the identification signal 126 in which the personnel device 130 is also configured to alert to the person 210 that the announcement device 110 is located within a detectable range of the personnel device 130, and the personnel device 130 is also configured to allow the person 210 to select and activate a desired feedback selection signal 142 to transmit from the personnel device 130.

The personnel device 130 may be configured as any type of design such as those selected from the group consisting of a hand held personnel device 130, a earphone personnel device 130, a walking cane personnel device 130, a palm computer personnel device 130, a wearable personnel device 130, a necklace personnel device 130, a mobile phone personnel device 130, a bracelet personnel device 130, a hearing aid personnel device 130, and a headset personnel device 130. The hearing aid personnel device 130 may be equipped with a coil and ‘T’ switch for the benefit of deaf or hearing impaired persons. Further the headset personnel device 130 may be a compatible monaural or binaural headset personnel device 130.

The personnel device 130 may be configured to have an alerting component 654 for use in alerting the person 210 which is capable of producing an alert signal selected from the group consisting of an audible alert signal, a buzzer alert signal, a visual alert signal, an electrical pulse alert signal, and a vibrating alert signal.

The identification signal 126 may be any type of identification signal 126 such as those selected from the group consisting of a radio frequency identification signal 126, an induction loop identification signal 126, an infrared identification signal 126, an acoustic identification signal 126, an ultrasound identification signal 126, and an infrasound identification signal 126. Accordingly, the corresponding transmitter 122 of the announcement device 110 may be selected from the group consisting of a radio frequency transmitter 122, an induction loop transmitter 122, an infrared transmitter 122, an acoustic transmitter 122, an ultrasound transmitter 122, and an transmitter 122.

The announcement signals 160 may be any type of announcement signals 160 such as those selected from the group consisting of siren announcement signals 160, periodic beeping announcement signals 160, digital data files announcement signals 160, electromagnetic pulses announcement signals 160, induction loop pulses announcement signals 160, and different languages announcement signals 160. One preferred embodiment is that at least one of the announcement signals 160 comprises a spoken language announcement signal 160. Accordingly, the detector 180 of the personnel device 130 may be the person 210 hearing or even seeing the announcement signals 160, and the detector 180 of the personnel device 130 detecting the announcement signals 160.

The onsite location 220 may be any onsite location 220 such as those selected from the group consisting of a traffic light onsite location 220, a car onsite location 220, a taxicab onside location, an elevator onsite location 220, an entranceway onsite location 220, a doorway onsite location, a train onsite location 220, a bus onsite location 220, and a building onsite location 220.

One preferred embodiment is that the announcement device 110 is that it is configured to constantly emit the identification signal 126.

The announcement device 110 may optionally be configured to receive the feedback selection signal 142 and to produce anyone of a plurality of announcement signals 160 in response to the received feedback selection signal 142.

The announcement device 110 may also optionally comprise a notification indicator 118 configured to activate in response to when the announcement device 110 receives the feedback selection signal 142 from the personnel device 130.

The announcement device 110 may also optionally comprise a measuring module 146 configured to measure an approximate position of the person 210 relative to the announcement device 110.

The announcement device 110 may also optionally comprise a message storage facility 114 configured to store previously recorded announcement signals 160.

The personnel device 130 may optionally comprise a plurality of buttons 134, 138 for allowing the person 210 to selectively activate the desired feedback selection signal 142.

The system 100 may optionally comprise a plurality of announcement devices 110, and a plurality of personnel devices 130.

The system 100 may further comprise a central computer 510 and a local area network (LAN) 514. The central computer 510 is used to store a plurality of announcement signals 160. The LAN 514 is operatively connected to the central computer 510 such that a plurality of announcement device 110 can be operatively connected to the LAN 514 and operatively connected to the central computer 510. Further the personnel device 130 can be configured to detect anyone identification signal 126 emitted from anyone of the announcement device 110, so that the personnel device 130 can alert to the person 210 that anyone of the announcement device 110 is located within the detectable range of the personnel device 130. The LAN 514 may be any LAN 514 such as those selected from the group consisting of a wired LAN 514 and a wireless LAN.

One embodiment of the personnel device 130 for providing onsite information to a visually impaired person 210 comprises: a means for detecting an identification signal 126; a means for alerting to the person 210 that an announcement device 110 is located within a detectable range of the personnel device 130; and a means for allowing the person 210 to select and activate a desired feedback selection signal 142 to transmit from the personnel device 130; and a means for broadcasting the feedback selection signal. The means for detecting an identification signal 126 may be a detector 180 selected from the group consisting of radio frequency detector 180, an infrared detector 180, an acoustic detector 180, an ultrasound detector 180, and an infrasound detector 180, and an induction loop detector 180 such as a coil mounted in a hearing aid coupled to a ‘T’ switch for the benefit of deaf or hearing impaired persons. The means for alerting may be any alert responder 182 such as those selected from the group consisting of an alert responder 182, a buzzer alert responder 182, a visual alert responder 182, a vibrating alert responder 182, and an electrical pulse alert responder 182. The means for allowing the person 210 to select and activate a desired feedback selection signal 142 to transmit from the personnel device 130 can be a plurality of push buttons 134, 138. The means for broadcasting the feedback selection signal may be any

One embodiment of the announcement device 110 comprises: an means for emitting an identification signal 126; a means for receiving a feedback selection signal 142; a means for producing anyone of a plurality of recorded announcement signals 160 in response to the received feedback selection signal 142; a means for visually indicating that the announcement device 110 receives the feedback selection signal 142 from a personnel device 130; a means for measuring module 146 configured to measure an approximate position of the person 210 relative to the announcement device 110; and a means for storing recorded announcement signals 160. The means for emitting an identification signal 126 may be an emitter 184 selected from the group consisting of radio frequency emitter 184, an induction loop emitter 184, an infrared emitter 184, an acoustic emitter 184, an ultrasound emitter 184, and an infrasound emitter 184. The means for receiving a feedback selection signal 142 may be a receiver 188 selected from the group consisting of radio frequency receiver 188, an induction loop receiver 188, an infrared receiver 188, an acoustic receiver 188, an ultrasound receiver 188, and an infrasound receiver 188. The means for producing anyone of a plurality of recorded announcement signals 160 may be any transmitter 122 selected from the group consisting of a speaker transmitter 122, radio frequency transmitter 122, an induction loop transmitter 122, an infrared transmitter 122, an acoustic transmitter 122, an ultrasound transmitter 122, and an infrasound transmitter 122. The means for visually indicating that the announcement device 110 receives the feedback selection signal 142 may be a notification indicator 118 selected from the group consisting of a incandescent bulb notification indicator 118, a light emitting diode notification indicator 118, an electric arc notification indicator 118, a moving sign notification indicator 118, a liquid crystal notification indicator 118, a flashing sign notification indicator 118. The means for measuring module 146 may be selected from the group consisting of a radar measuring module 146, a radio frequency signal intensity measuring module 146, an induction loop signal intensity measuring module 146, an infrared signal intensity measuring module 146, an acoustic signal intensity measuring module 146, an ultrasound signal intensity measuring module 146, and an infrasound signal intensity measuring module 146. The means for storing recorded announcement signals 160 may a message storage facility 114 selected from the group consisting of computer message storage facility 114, a semiconductor chip message storage facility 114, and a random access memory message storage facility 114.

One embodiment of a method for providing onsite information to a visually impaired person 210 comprises the steps of alerting, detecting, emitting, installing, pushing, receiving, and sending and transmitting. The installing step comprises installing an announcement device 110 at an onsite location 220. The emitting step comprises emitting an identification signal 126 from the installed announcement device 110. The detecting step comprises detecting the identification signal 126 using a personnel device 130 configured to detect the identification signal 126. The alerting step comprises alerting, by using the personnel device 130, the person 210 that the announcement device 110 is located within a detectable range of the personnel device 130. The pushing step comprises pushing at least one button 134, 138 on the personnel device 130 to select a feedback selection signal 142. The sending step comprises sending a feedback signal from the personnel device 130. The receiving step comprises receiving the feedback signal at the announcement device 110. The transmitting step comprises transmitting an announcement signal 160 from the announcement device 110 in response to the received feedback selection signal 142.

An optional set of steps of recording, storing and measuring may be added to the method for providing onsite information to a visually impaired person 210. The optional recording step comprises recording announcement signals 160. The optional storing step comprises storing the recorded announcement signals 160 in a message storage facility 114 of the announcement device 110. The optional measuring step comprises measuring a distance between the announcement device 110 and the personnel device 130.

As to the manner of usage and operation of the present invention, the same should be apparent from the above description. Accordingly, no further discussion relating to the manner of usage and operation will be provided.

While a number of preferred embodiments of the system, device and methods has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for providing onsite information to a visually impaired person, the system comprising:
an announcement device configured to be installed at an onsite location wherein the announcement device is configured to emit an identification signal; and
a personnel device configured to detect the identification signal wherein the personnel device is also configured to alert to the person that the announcement device is located within a detectable range of the personnel device, and the personnel device is also configured to allow the person to select and activate a desired feedback selection signal to transmit from the personnel device.

2. The system of claim 1 wherein the announcement device is further configured to receive the feedback selection signal and is also configured to produce anyone of a plurality of announcement signals in response to the received feedback selection signal.

3. The system of claim 1 wherein the announcement device further comprises a notification indicator configured to activate in response to when the announcement device receives the feedback selection signal from the personnel device.

4. The system of claim 1 wherein the announcement device further comprises a measuring module configured to measure an approximate position of the person relative to the announcement device.

5. The system of claim 1 wherein the announcement device further comprises a message storage facility configured to store previously recorded announcement signals.

6. The system of claim 1 wherein the announcement device is configured to constantly emit the identification signal.

7. The system of claim 1 wherein the personnel device further comprises a plurality of buttons for allowing the person to selectively activate the desired feedback selection signal.

8. The system of claim 1 wherein the identification signal is selected from the group consisting of a radio frequency identification signal, an induction loop identification signal, an infrared identification signal, an acoustic identification signal, an ultrasound identification signal, and an infrasound identification signal.

9. The system of claim 1 wherein the personnel device is selected from the group consisting of a hand held personnel device, a earphone personnel device, a hearing aid personnel device, a walking cane personnel device, a palm computer personnel device, a wearable personnel device, a necklace personnel device, a mobile phone personnel device, a bracelet personnel device, and a headset personnel device.

10. The system of claim 2 wherein at least one of the announcement signals comprise a spoken language announcement signal.

11. The system of claim 1 wherein the onsite location is selected from the group consisting of a traffic light onsite location, a car onsite location, a taxicab onside location, an elevator onsite location, an entrance way onsite location, a bus onsite location, and a building onsite location.

12. The system of claim 1 further comprising a plurality of announcement devices, and a plurality of personnel devices.

13. The system of claim 1 wherein the personnel device is configured to have an alerting component for alerting the person by producing an alert signal selected from the group consisting of an audible alert signal, a buzzer alert signal, a visual alert signal, an electrical pulse alert signal, and a vibrating alert signal.

14. The system of claim 1 further comprising
a central computer used to store a plurality of announcement signals;
a local area network (LAN) operatively connected to the central computer;
a plurality of announcement devices operatively connected to the LAN and operatively connected to the central computer; and
the personnel device configured to detect anyone identification signal from anyone of the announcement devices, the personnel device configured to alert to the person that anyone of the announcement devices is located within the detectable range of the personnel device, and the personnel device configured to allow the person to select and activate a desired feedback selection signal.

15. The system of claim 14 wherein the LAN is selected from the group consisting of a wired LAN and a wireless LAN.

16. A personnel device for providing onsite information to a visually impaired person, the personnel device comprising:
a means for detecting an identification signal;
a means for alerting to the person that an announcement device is located within a detectable range of the personnel device; and
a means for allowing the person to selecting and activating a desired feedback selection signal to transmit from the personnel device; and
a means for broadcasting the feedback selection signal.

17. A announcement device for providing onsite information to a visually impaired person, the announcement device comprising:
an means for emitting an identification signal;
a means for receiving a feedback selection signal;
a means for producing anyone of a plurality of recorded announcement signals in response to the received feedback selection signal;
a means for visually indicating that the announcement device receives the feedback selection signal from a personnel device;
a means for measuring module configured to measure an approximate position of the person relative to the announcement device; and
a means for storing recorded announcement signals.

18. A method for providing onsite information to a visually impaired person comprising the steps of:
installing an announcement device at an onsite location;
emitting an identification signal from the installed announcement device;
detecting the identification signal using a personnel device configured to detect the identification signal;
alerting, by using the personnel device, the person that the announcement device is located within a detectable range of the personnel device;
pushing at least one button on the personnel device to select a feedback selection signal;
sending a feedback signal from the personnel device;
receiving the feedback signal at the announcement device; and
transmitting an announcement signal from the announcement device in response to the received feedback selection signal.

19. The method of claim 18 further comprising the steps of:
recording announcement signals; and
storing the recorded announcement signals in a message storage facility of the announcement device.

20. The method of claim 18 further comprising the step of measuring a distance between the announcement device and the personnel device.
